(19) United States
(12) Patent Application Publication
(10) Pub. No.: US 2025/0223159 A1
(43) Pub. Date: Jul. 10, 2025

(54) METHOD FOR REFORMING CARBON DIOXIDE AND METHANE USING CATALYZED PLASMA REACTOR

(71) Applicant: Samsung Electronics Co., Ltd., Suwon-si (KR)

(72) Inventors: Jongmin Lee, Suwon-si (KR); Junkyu Kim, Suwon-si (KR); Jinwoo Kim, Suwon-si (KR); Sungwoo Kang, Suwon-si (KR); Dongwook Kim, Suwon-si (KR); Hyunah Kim, Suwon-si (KR); Jaehee Chang, Suwon-si (KR); Hyukjae Kwon, Suwon-si (KR); Youhwan Son, Suwon-si (KR)

(21) Appl. No.: 19/003,416

(22) Filed: Dec. 27, 2024

(30) Foreign Application Priority Data
Jan. 8, 2024 (KR) 10-2024-0003115

(51) Int. Cl. C01B 3/34; B01J 8/02; B01J 21/08; B01J 23/02; B01J 23/755; B01J 23/94; B01J 38/12; C01B 3/40

(52) U.S. Cl. CPC C01B 3/342; B01J 8/0278; B01J 21/08; B01J 23/02; B01J 23/755; B01J 23/94; B01J 38/12; C01B 3/40; C01B 2203/0238; C01B 2203/0861; C01B 2203/1058; C01B 2203/1082; C01B 2203/1241

(57) ABSTRACT

A method for reforming carbon dioxide and methane by using a catalyzed plasma reactor, the method includes providing a dielectric barrier discharge plasma reactor including a catalyst bed in a plasma discharge zone, injecting a reaction gas into the plasma reactor, generating plasma within the plasma discharge zone of the plasma reactor, generating a reformed gas by interaction between the plasma and the catalyst bed, and separating the reformed gas. The reaction gas includes methane, carbon dioxide, oxygen, and inert gas, the reformed gas includes carbon monoxide and hydrogen, and the oxygen is about 2 volume percent to about 15 volume percent of a total volume of the reaction gas.

### CROSS-REFERENCE TO RELATED APPLICATION

This application is based on and claims priority to Korean Patent Application No. 10-2024-0003115, filed on Jan. 8, 2024, in the Korean Intellectual Property Office and all the benefits accruing therefrom under 35 U.S.C. § 119, the content of which is herein incorporated by reference in its entirety.

### BACKGROUND

### 1. Field

The disclosure relates to a method for reforming carbon dioxide and methane using a catalyzed plasma reactor.

### 2. Description of the Related Art

Methane, which makes up most of natural gas, is used in various fields as a raw material for energy production through combustion or as a raw material for producing synthetic gas through reforming. In addition, methane is a representative greenhouse gas along with carbon dioxide. Reforming carbon dioxide and methane can provide a route for the synthesis of useful gases while reducing greenhouse gas emissions.

To enhance energy efficiency, interest in the on reforming carbon dioxide and methane with a catalyst and plasma has arisen. A need remains to overcome limitations in the life of a catalyst caused by reaction byproducts of the reforming process.

### SUMMARY

Provided is a method for reforming carbon dioxide and methane using a catalyzed plasma reactor with excellent energy efficiency and enhanced catalyst life.

Additional aspects will be set forth in part in the description which follows and, in part, will be apparent from the description, or may be learned by practice of the presented embodiments of the disclosure.

According to an aspect of the disclosure, a method for reforming carbon dioxide and methane using a catalyzed plasma reactor includes providing a dielectric barrier discharge plasma reactor including a catalyst bed in a plasma discharge zone, injecting a reaction gas into the plasma reactor, generating a plasma within the plasma discharge zone of the plasma reactor, generating a reformed gas by interaction between the plasma and the catalyst bed, and separating the reformed gas.

The reaction gas includes methane, carbon dioxide, oxygen, and inert gas, the reformed gas includes carbon monoxide and hydrogen, and the oxygen is about 2 volume percent to about 15 volume percent of a total volume of the reaction gas.

In an embodiment, the methane may be about 10 volume percent to about 30 volume percent of the total volume of the reaction gas.

In an embodiment, the carbon dioxide may be about 15 volume percent to about 45 volume percent of the total volume of the reaction gas.

In an embodiment, the plasma reactor may include a body providing a plasma discharge zone, an internal electrode within the plasma discharge zone, an external electrode defining the plasma discharge zone and disposed on an outer surface of the body, and a dielectric barrier between the internal electrode and the external electrode.

In an embodiment, the body may constitute the dielectric barrier.

In an embodiment, the body may include quartz.

The external electrode may include a metal mesh.

In an embodiment, the catalyst bed may include Ni, Cu, Pd, Pt, Ag, Fe, or a combination thereof.

In an embodiment, the catalyst bed may include a metal oxide doped with Ni, Cu, Pd, Pt, Ag, Fe, or a combination thereof.

The catalyst bed may include a metal oxide coated with Ni, Cu, Pd, Pt, Ag, Fe, or a combination thereof.

The metal oxide may include Al₂O₃, SiO₂, MgO, CeO₂, or a combination thereof.

The catalyst bed may include Ni/Al₂O₃, Ni/SiO₂, Ni/MgO, Cu/Al₂O₃, Pd/Al₂O₃, Pd/CeO₂, Pt—Re/Al₂O₃, Ag/Al₂O₃, Fe/Al₂O₃, LaFeO₃, La₂O₃, Ni/MgAl₂O₄, NiFe₂O₄/SiO₂, Ni/Al₂O₃—MgO, BaFe_{0.5}Nb_{0.5}O₃, LaNi₂O₃/SiO₂, Na-ZSM-5, TiO₂/g-C₃N₄, BaTiO₃, or a combination thereof.

In the step of generating the reformed gas, a coke disposed on the surface of the catalyst bed may be removed by reacting with oxygen species generated by the plasma.

After the step of generating the reformed gas, the catalyst bed may not include the coke.

The temperature of the plasma discharge zone may be about 15° C. to about 35° C.

The flow rate of the reaction gas per weight of the catalyst may be about 0.1 liters per hour-gram to about 10 liters per hour-gram.

The inert gas may include helium, nitrogen, argon, or a combination thereof.

In an embodiment, the step of generating the plasma may include applying an alternating current pulse voltage to the internal electrode.

The alternating current pulse voltage may have a frequency of 40 kilohertz (kHz) to 90 kHz, a peak voltage of 1 kilovolts (kV) to 3 kV, and a pulse width of 1 microsecond (μs) to 9 μs.

Some of the reformed gas may pass through a component analyzer.

A plasma reactor including a body providing a plasma discharge zone; a catalyst bed in the plasma discharge zone; an internal electrode within the plasma discharge zone; an external electrode defining the plasma discharge zone and disposed on an outer surface of the body; and a dielectric barrier disposed between the internal electrode and the external electrode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a dielectric barrier discharge plasma reactor used for reforming carbon dioxide and methane, according to an embodiment;

FIG. 2 is a schematic diagram of a carbon dioxide and methane reforming system used for reforming carbon dioxide and methane, according to an embodiment;

FIG. 3 is a flowchart showing a method of reforming carbon dioxide and methane by using a dielectric barrier discharge plasma reactor according to an embodiment;

FIG. 4 is a photograph of a dielectric barrier discharge plasma reactor used in the Examples; and

FIG. 5 is a graph for comparing the overall conversion rate (percent, %) of carbon dioxide and methane versus reaction temperature (° C.) in Example 1, Comparative Example 1, and Comparative Examples 3 to 10.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, as the disclosure allows for various changes and numerous embodiments, particular embodiments will be illustrated in the drawings and described in detail in the detailed description. However, this is not intended to limit the disclosure to particular modes of practice, and it is to be appreciated that all changes, equivalents, and substitutes that do not depart from the spirit and technical scope are encompassed in the disclosure.

The terms used herein are merely used to describe particular embodiments, and are not intended to limit the disclosure. An expression used in the singular encompasses the expression of the plural, unless it has a clearly different meaning in the context. As used herein, it is to be understood that the terms such as “includes,” “have,” and “comprise” are intended to indicate the presence of the features, numbers, steps, actions, components, parts, ingredients, materials, or combinations thereof disclosed in the specification, but do not preclude the possibility that one or more other features, numbers, steps, actions, components, parts, ingredients, materials, or combinations thereof may exist or may be added. The symbol “/” used herein may be interpreted as “and” or “or” according to the context.

In the drawings, the diameters, lengths, and thicknesses of layers and regions are exaggerated or reduced for clarity. Throughout the specification, like reference numerals refer to like elements. Throughout the specification, it is to be understood that when a component, such as a layer, a film, a region, or a plate, is referred to as being “on” another component, the component can be directly on the other component or intervening components may be present thereon. Throughout the specification, the terms “first,” “second,” etc. may be used to describe various elements, these elements, components, regions, layers and/or sections should not be limited by these terms. These terms are only used to distinguish one element from another element. In this specification and drawings, components having substantially the same functional configuration are given the same reference numerals, and redundant description is omitted.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

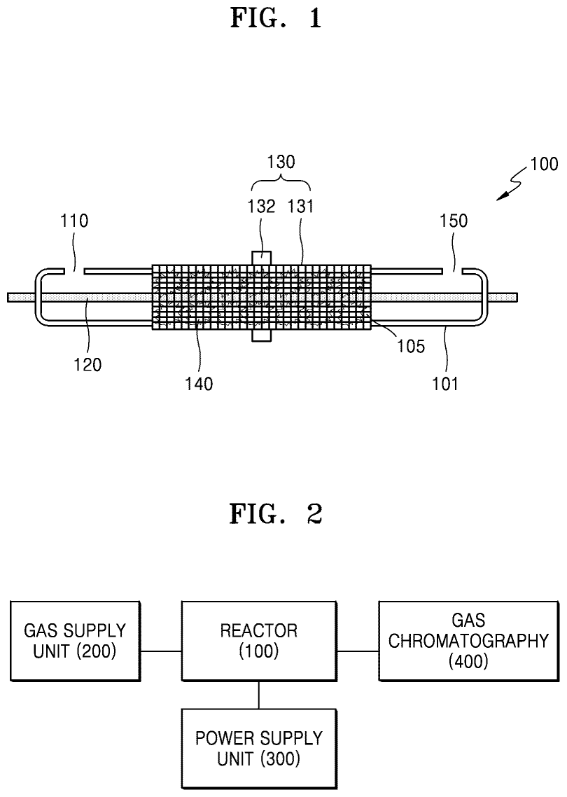

FIG. 1 is a schematic diagram of a dielectric barrier discharge plasma reactor 100 used for reforming carbon dioxide and methane according to an embodiment. Referring to FIG. 1, the dielectric barrier discharge plasma reactor 100 includes a body 101, a gas inlet 110, an internal electrode 120, an external electrode 130, a catalyst bed 140, and a gas outlet 150. The internal electrode 120 and external electrode 130 define a plasma discharge zone 105.

Reforming can occur as a reaction gas containing injected carbon dioxide and methane passes through the plasma discharge zone 105 including the catalyst bed 140.

The body 101 may provide an interior and includes the internal electrode 120 therein, and the external electrode 130 may be formed outside the body 101 to be coaxial with the internal electrode 120. The body 101 may comprise a dielectric material and may serve as a dielectric barrier between the internal electrode 120 and the external electrode 130. The body 101 may be made of, for example, a quartz tube. Quartz, as used herein, refers to a crystalline or cryptocrystalline mineral comprising silicon-oxygen tetrahedra, with the chemical formula of SiO₂.

The internal electrode 120 is an electrode to which voltage is applied for a dielectric barrier discharge, and is disposed within the interior of the body 101 so as to be parallel to the long axis. The internal electrode 120 can be disposed at the center of the interior of the body 101. The internal electrode 120 may have a rod shape.

The external electrode 130 may include a metal mesh 131 formed to surround the outer wall of the body 101 and a power connection unit 132 that connects the metal mesh 131 to a power source. The external electrode 130 may be a ground electrode. When a voltage is applied to the internal electrode 120, plasma discharge may occur in a space 105 between the internal electrode 120 and the external electrode 130 due to a voltage difference.

The internal electrode 120 and external electrode 130 may be made of stainless steel, for example.

The catalyst bed 140 may be formed in the plasma discharge zone 105 located between the internal electrode 120 and the dielectric body 101. The catalyst bed 140 may contain a catalyst having an appropriate form. The catalyst may comprise, for example, powders, pellets or a coating disposed on a support. The catalyst may further promote the conversion of carbon dioxide and methane by the plasma.

The catalyst may include a metal having catalytic activity. The metal may include, for example, Ni, Cu, Pd, Pt, Ag Fe, or a combination thereof. A Ni-based catalyst may include Ni doped or undoped by, for example, Fe, Co, Cu, La, or a combination thereof. The support may include, for example, a metal oxide such as Al₂O₃, ZrO₂, TiO₂, SiO₂, ZnO, MgO, CaO, CeO₂, zeolite, or a combination thereof. In one embodiment, the catalyst may be a mixture of a metal oxide and a catalytically active metal or a metal oxide doped with a catalytically active metal.

The catalyst may include, for example, Ni/Al₂O₃, Ni/SiO₂, Ni/MgO, Cu/Al₂O₃, Pd/Al₂O₃, Pd/CeO₂, Pt—Re/Al₂O₃, Ag/Al₂O₃, Fe/Al₂O₃, LaFeO₃, La₂O₃Ni/MgAl₂O₄, NiFe₂O₄/SiO₂, Ni/Al₂O₃—MgO, BaFe_{0.5}Nb_{0.5}O₃, LaNi₂O₃/SiO₂, Na-ZSM-5, TiO₂/g-C₃N₄, BaTiO₃, or a combination thereof, but not limited thereto.

### Reactor System

FIG. 2 is a schematic diagram of a carbon dioxide and methane reforming system used for reforming carbon dioxide and methane according to an embodiment. Referring to FIG. 2, the carbon dioxide and methane reforming system includes a dielectric barrier discharge plasma reactor 100, a gas supply unit 200 connected to the gas inlet of the reactor, a power supply unit 300 that supplies power to the reactor, a gas chromatograph 400 connected to the lower end of the reactor.

The configuration of the dielectric barrier discharge plasma reactor 100 is the same as described above.

The gas supply unit 200 is a unit that supplies carbon dioxide, methane, oxygen, and an inert gas to the dielectric barrier discharge plasma reactor 100. The supplied gases can react within the reactor 100. The gas supply unit 200 may supply each gas individually or in combination by adjusting the flow rate using, for example, a mass flow controller (MFC). In addition, carbon dioxide, methane, oxygen, and inert gas can be mixed in a desired ratio and supplied simultaneously.

The power supply unit 300 is a unit that may supply alternating current (AC) power or direct current (DC) power to generate the plasma within the reactor 100. The power supply unit 300 may apply, for example, an alternating current pulse voltage having a frequency of 40 to 90 kilohertz (kHz) to the internal electrode of the reactor 100. The pulse voltage may have a peak voltage of, for example, 1 kilovolts (kV) to 3 kV.

At least some of exhaust gas containing the gas generated by reforming in the reactor 100 passes through the gas chromatograph 400, and the components and concentration of the exhaust gas can be analyzed in the gas chromatograph 400 to determine the conversion rate, selectivity, energy efficiency, and so forth, in the reforming reaction.

Although not shown in FIG. 2, the carbon dioxide and methane reforming system may include a control unit that controls operations of various units constituting the system, that is, the reactor 100, the gas supply unit 200, the power supply unit 300, and the gas chromatograph 400.

### Methane Reforming Method

A reforming reaction of methane using carbon dioxide has the advantage of reducing greenhouse gas emissions in that carbon dioxide can be recycled. In addition, the reforming reaction of methane using carbon dioxide can produce synthesis gas (for example, H₂:CO in a ratio of 1:1) having a greater carbon monoxide content than other reforming methods, and the generated synthesis gas can be applied to the process of producing high value-added chemical products, such as oxoalcohol, dimethyl ether (DME), polycarbonate (PC), and acetic acid. The reforming reaction of methane using carbon dioxide proceeds according to the following reaction formula (1):
CH₄+CO₂→2CO+2H₂ (1). The standard enthalpy at 298 Kelvins (ΔH⁰₂₉₈) is +247.3 kilojoules per mole (kJ/mol).

As an endothermic reaction, an equilibrium conversion rate, which is a theoretical maximum conversion rate at a given temperature, increases as the temperature increases. Generally, the reaction occurs at a temperature of 650° C. or greater, and the reaction usually proceeds at a temperature of 850° C.

In the methane reforming reaction using carbon dioxide according to the present embodiment, reaction energy is supplied to reactants and a catalyst surface by plasma discharge, and various active species perform a conversion reaction on the catalyst surface. Therefore, the conversion reaction may be performed using a relatively low amount of power without supplying additional heat energy to the reactor.

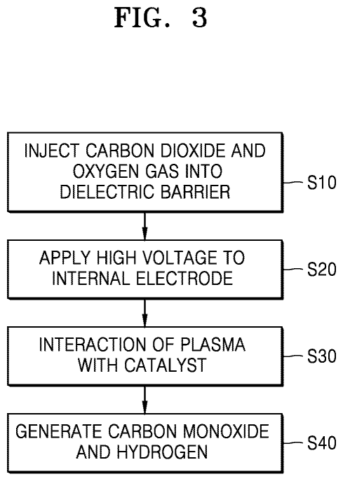

FIG. 3 is a flowchart showing a method of reforming carbon dioxide and methane using the dielectric barrier discharge plasma reactor according to an embodiment.

Referring to FIG. 3, carbon dioxide, methane, and oxygen gas are injected into the dielectric barrier discharge plasma reactor through the gas inlet (S10). Here, inert gas may be added to facilitate the generation of plasma. The inert gas may contain, for example, helium, nitrogen, argon, or a combination thereof. The reaction gas may be a mixed gas of carbon dioxide, methane, oxygen, and inert gas.

The methane may be, for example, 10 volume percent (vol %) to 30 vol %, 12 vol % to 28 vol %, or 15 vol % to 25 vol % of the total volume of the reaction gas. For example, the volume ratio of methane to the reaction gas may be 0.1 to 0.3, 0.12 to 0.28, or 0.15 to 0.25, and so forth. The carbon dioxide may be, for example, 15 vol % to 45 vol %, 18 vol % to 42 vol %, or 20 vol % to 30 vol % of the total volume of the reaction gas. The oxygen may be, for example, 2 vol % to 15 vol %, 3 vol % to 13 vol %, or 5 vol % to 10 vol % of the total volume of the reaction gas. The remaining volume of the reaction gas may be due to the inert gas.

When methane, carbon dioxide, and oxygen are present in the ratio stated above in the reaction gas, the conversion rate of methane and carbon dioxide and the selectivity of generated carbon monoxide and hydrogen may be enhanced.

The flow rate of the total reaction gas per weight of catalyst in the reactor may be about 0.1 liters per hour-grams (L/h·g) to about 10 L/h·g. When the flow rate of the total reaction gas per weight of catalyst in the reactor is in the ratio stated above, the conversion rate of methane and carbon dioxide and the selectivity of generated carbon monoxide and hydrogen may be enhanced.

A high voltage may be applied to the internal electrode of the dielectric barrier discharge plasma reactor (S20). The high voltage may be supplied from the power supply unit connected to the reactor. The power supply unit may supply AC power or DC power. For example, an alternating pulse voltage having a frequency of 40 kHz to 90 kHz, a peak voltage of 1 kV to 3 kV, and a pulse width of 1 μs to 9 μs may be applied to the internal electrode of the reactor.

By applying high voltage, a plasma can be generated from the reaction gas within a plasma discharge zone containing a catalyst bed in the reactor, and the conversion reaction of carbon dioxide and methane can occur due to the interaction between the plasma and the catalyst (S30).

By applying high voltage, a plasma can be formed from methane, carbon dioxide, oxygen, and inert gas in the plasma discharge zone. The plasma may include various chemical species formed from the reaction gases.

A gas phase reaction in which active species, such as excited electrons and radicals, are generated from the reaction gas in the plasma discharge zone, an adsorption reaction in which active species are adsorbed into the active site on the catalyst surface, and a reaction between active species adsorbed into the catalyst surface, may occur. It is understood that micro (nano)-discharge between the pores of the catalyst bed may have a synergistic effect on the reaction between plasma and catalyst.

Carbon monoxide and hydrogen can be generated by the interaction between the plasma generated from the reaction gas and the catalyst (S40). In the reforming of methane using carbon dioxide, carbon may accumulate on the catalyst surface, which may reduce the activity of the catalyst. In the present embodiment, due to the presence of the oxygen gas in the injected reaction gas, at least a portion of a coke disposed on the catalyst surface in the reforming reaction can be removed (or converted) by reacting with oxygen species excited by plasma. In this manner, the conversion rate and energy efficiency of the reaction gas can be enhanced or maintained. Coke, as used herein, refers to amorphous carbon accumulations including carbon and hydrocarbons.

### EXAMPLES

The disclosure is explained in more detail through the following examples and comparative examples. However, the following examples are provided for illustrating the disclosure and are not intended to limit the scope of the disclosure.

### Example 1

Reforming of methane and carbon dioxide was performed using a dielectric barrier discharge plasma reactor.

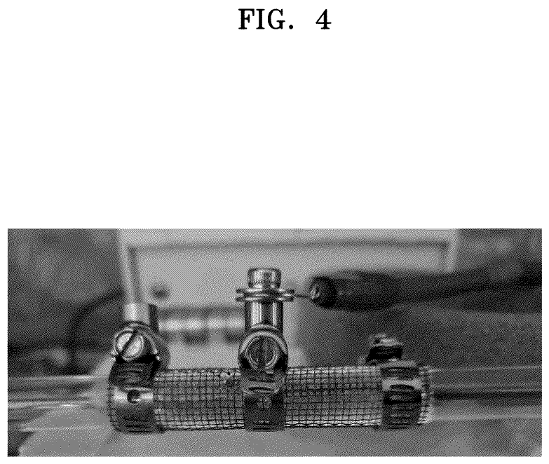

FIG. 4 is a photograph of a dielectric barrier discharge plasma reactor used in the Examples. Referring to FIG. 4, the plasma reactor used in this example includes a quartz tube having a length of 30 centimeters (cm), an inner diameter of 1.1 cm, and a thickness of 2 millimeters (mm), an internal electrode traversing the interior of the quartz tube, and an external electrode consisted of an 8 cm wide metal mesh surrounding the outside of the quartz tube. Both the internal electrode and external electrode were composed of SUS304 stainless steel. In the dielectric barrier discharge plasma reactor, the quartz tube served as a dielectric barrier. Referring to FIG. 4, plasma was generated in a portion surrounded by the external electrode in the inner area of the quartz tube.

A catalyst bed was formed using 2.4 grams (g) of Ni/MgO catalyst within a plasma generation area. Both ends of the catalyst bed were limited to quartz wool. The Ni/MgO catalyst was in the form of granules, consisting of Ni particles on Ni-doped MgO, and containing Ni in an amount of 40 mole percent (mol %) based on the total moles of the metal of the catalyst.

A gas inlet was formed at one end of the plasma reactor, and a gas outlet was formed at the opposing end. A reaction gas was injected into the gas inlet, and the reformed gas was discharged through the gas outlet. As the reaction gas, carbon dioxide, methane, oxygen and helium were used. Helium functioned as an atmospheric gas that formed an electric discharge. A gas line incorporating supply lines for each gas was connected to the gas inlet.

Carbon dioxide, methane, oxygen, and helium were injected into the reactor at flow rates of 120 milliliters per minute (mL/min), 80 mL/min, 10 mL/min, and 190 mL/min, respectively. Plasma was generated by applying a voltage of 1 to 3 kV to the internal electrode of the plasma reactor. The measured temperature in the plasma discharge zone was 25° C. A gas chromatograph was connected to the gas outlet to confirm the components of the reformed gas.

### Example 2

Reforming of carbon dioxide and methane was performed in the same manner as in Example 1, except that 2 g of Ni/SiO₂ (Ni 22.5 mol %) catalyst, instead of Ni/MgO catalyst, was used in the catalyst bed, and carbon dioxide, methane, oxygen, and helium were injected at flow rates of 100 mL/min, 100 mL/min, 10 mL/min, and 190 mL/min, respectively.

### Example 3

Reforming of carbon dioxide and methane was performed in the same manner as in Example 2, except that carbon dioxide, methane, oxygen, and helium were injected at flow rates of 100 mL/min, 100 mL/min, 50 mL/min, and 150 mL/min, respectively.

### Comparative Example 1

Reforming of carbon dioxide and methane was performed in the same manner as in Example 1, except that oxygen was not included in the reaction gas, and carbon dioxide, methane, and helium were injected at flow rates of 120 mL/min, 80 mL/min, and 200 mL/min, respectively.

### Comparative Example 2

Reforming of carbon dioxide and methane was performed in the same manner as in Example 2, except that oxygen was not included in the reaction gas, and carbon dioxide, methane, and helium were injected at flow rates of 100 mL/min, 100 mL/min, and 200 mL/min, respectively.

### Comparative Example 3

Reforming of carbon dioxide and methane was performed by using a thermocatalytic reactor. The thermocatalytic reactor was composed of a metal reactor with a ¼ inch inner diameter, which fixed the catalyst bed, a heater that transferred heat for the reaction to the catalyst bed in the reactor, a device that injected reaction gas into the reactor, and a gas chromatograph connected to the bottom of the reactor. The same catalyst of Example 1 was used in the catalyst bed.

While maintaining the temperature in the reactor at 450° C., carbon dioxide, methane, oxygen, and helium were injected into the reactor at flow rates of 120 mL/min, 80 mL/min, 10 mL/min, and 190 mL/min, respectively.

### Comparative Examples 4 to 10

Reforming of carbon dioxide and methane was performed in the same manner as in Comparative Example 3, except that the reactor temperature and flow rates of carbon dioxide, methane, oxygen, and helium as shown in Table 1 were used.

Table 1 provides reactor types, reactor temperatures, catalysts, reaction gas flow rates, and presence of oxygen, used in Examples 1 to 3 and Comparative Examples 1 to 10. DBD refers to a Dielectric Barrier Discharge reactor.

TABLE 1

| | | Reactor | | | |
|---|---|---|---|---|---|
| | Reactor | temperature | Catalyst | CO₂/CH₄/O₂/He | Presence of O₂ |
| Example 1 | DBD | 25° C. | Ni/MgO | 120:80:10:190 | ∘ |
| Example 2 | DBD | 25° C. | Ni/SiO₂ | 100:100:10:190 | ∘ |
| Example 3 | DBD | 25° C. | Ni/SiO₂ | 100:100:50:150 | ∘ |
| Comparative | DBD | 25° C. | Ni/MgO | 120:80:0:200 | x |
| Example 1 | | | | | |
| Comparative | DBD | 25° C. | Ni/SiO₂ | 100:100:0:200 | x |
| Example 2 | | | | | |
| Comparative | Thermocatalyst | 450° C. | Ni/MgO | 120:80:10:190 | ∘ |
| Example 3 | | | | | |
| Comparative | Thermocatalyst | 450° C. | Ni/MgO | 120:80:0:200 | x |
| Example 4 | | | | | |
| Comparative | Thermocatalyst | 550° C. | Ni/MgO | 120:80:10:190 | ∘ |
| Example 5 | | | | | |
| Comparative | Thermocatalyst | 550° C. | Ni/MgO | 120:80:0:200 | x |
| Example 6 | | | | | |
| Comparative | Thermocatalyst | 650° C. | Ni/MgO | 120:80:10:190 | ∘ |
| Example 7 | | | | | |
| Comparative | Thermocatalyst | 650° C. | Ni/MgO | 120:80:0:200 | x |
| Example 8 | | | | | |
| Comparative | Thermocatalyst | 750° C. | Ni/MgO | 120:80:10:190 | ∘ |
| Example 9 | | | | | |
| Comparative | Thermocatalyst | 750° C. | Ni/MgO | 120:80:0:200 | x |
| Example 10 | | | | | |

### Evaluation Example

In Examples 1 to 3 and Comparative Examples 1 and 2, gas chromatography was performed while the plasma reactor was continuously operated for 1 hour to measure changes in the concentration of the reaction gas and the product gas.

Table 2 provides the conversion rates of carbon dioxide (CO₂) and methane (CH₄), the overall conversion rate, the selectivity of generated carbon monoxide (CO) and hydrogen (H₂), the molar ratio of generated H₂/CO, and the energy efficiency, as obtained from gas chromatography measurements in Examples 1 to 3 and Comparative Examples 1 and 2. The overall conversion rate is the average of the conversion rates of CO₂ and CH₄ reflecting the injection molar ratio of CO₂ and CH₄.

The conversion rates of carbon dioxide (CO₂) and methane (CH₄), the selectivities of generated carbon monoxide (CO) and hydrogen (H₂), and the reformed energy efficiency, were calculated by equations (2) to (6) below.

$${CO}_{2} conversion rate = ( 1 - \frac{{CO}_{2 ( out )}}{{CO}_{2 ( in )}} ) \times 100 \qquad ( 2 )$$

$${CH}_{4} conversion rate = ( 1 - \frac{{CH}_{4 ( out )}}{{CH}_{4 ( in )}} ) \times 100 \qquad ( 3 )$$

$$CO selectivity ( \% ) = ( \frac{{CO}_{( out )}}{( C {O}_{2 ( in )} - C {O}_{2 ( out )} ) + ( C {H}_{4 ( in )} - C {H}_{4 ( out )} )} ) \times 100 \qquad ( 4 )$$

$${H}_{2} selectivity ( \% ) = ( \frac{{H 2}_{( out )}}{2 * ( {CH}_{4 ( in )} - {CH}_{4 ( out )} )} ) \qquad ( 5 )$$

$$Energy efficiency ( \% ) = \frac{Minimum conversion energy per molecule}{Energy input per converted molecule} \times 100 \qquad ( 6 )$$

In equations (2) to (6), CO₂₍ᵢₙ₎ is the amount of CO₂ injected into the reactor, CO₂₍ₒᵤₜ₎ is the amount of CO₂ discharged from the reactor after the reaction, CH₄₍ᵢₙ₎ is the amount of CH₄ injected into the reactor, CH₄₍ₒᵤₜ₎ is the amount of CH₄ discharged from the reactor after the reaction, CO₍ₒᵤₜ₎ is the amount of CO generated and discharged after the reaction, and H₂₍ₒᵤₜ₎ is the amount of H₂ generated and discharged after the reaction.

The minimum conversion energy per molecule is calculated by a difference between the molecular energy levels before and after conversion of the reaction gas, and the energy input per converted molecule is calculated by the measured energy consumption and the amount of reformed gas.

TABLE 2

| | CO₂ | CH₄ | Overall | CO | H₂ | | Energy |
|---|---|---|---|---|---|---|---|
| | conversion | conversion | conversion | Selectivity | Selectivity | H₂/CO | efficiency |
| | rate (%) | rate (%) | rate (%) | (%) | (%) | ratio | (%) |
| Example 1 | 25.5 | 40.1 | 31.3 | 93.2 | 69.9 | 0.77 | 33.2 |
| Example 2 | 34.8 | 41.1 | 37.9 | 91.6 | 70.5 | 0.83 | 36.8 |
| Example 3 | 11.2 | 68.0 | 39.6 | 100.7 | 68.6 | 1.17 | 39.2 |
| CE 1 | 21.2 | 20.8 | 21.1 | 78.9 | 66.5 | 0.67 | 25.1 |
| CE 2 | 33.2 | 28.8 | 31.0 | 88.4 | 67.4 | 0.71 | 30.3 |

Referring to Table 2, when Examples 1 to 3 and Comparative Examples 1 and 2 (CE 1 and CE 2), in which a dielectric barrier discharge plasma reactor is used, are compared, the overall conversion rate, CO selectivity, H₂ selectivity and energy efficiency of Examples 1 to 3 were greater than those of Comparative Examples 1 and 2.

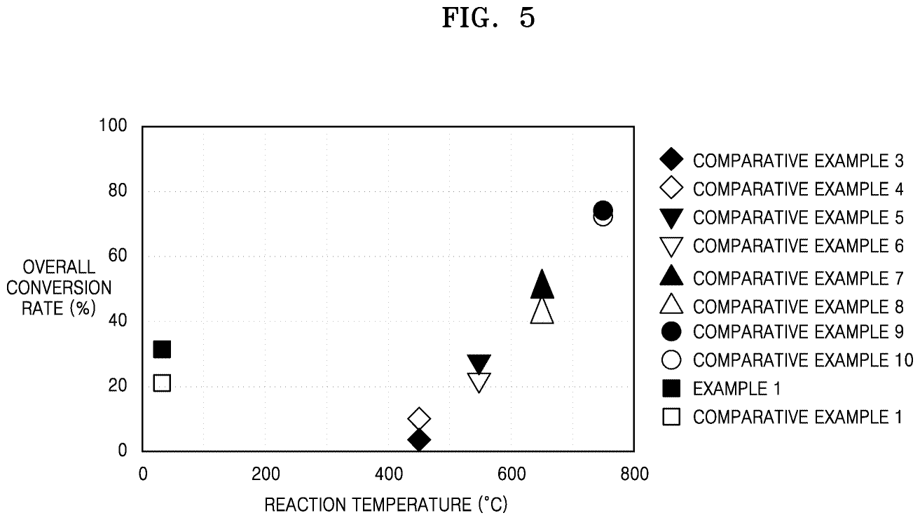

FIG. 5 is a graph illustrating the overall conversion rates of carbon dioxide and methane in Example 1 and Comparative Example 1, in which a dielectric barrier discharge plasma reactor was used, and Comparative Examples 3 to 10, in which a thermocatalytic reactor was used. Referring to FIG. 5, the overall conversion rates of carbon dioxide and methane in Comparative Examples 3 to 10, in which a thermocatalytic reactor is used, increase in proportion to the temperature of the reactor, and were greatest at 750° C. The overall conversion rates of carbon dioxide and methane in Example 1 and Comparative Example 1, in which a dielectric barrier discharge plasma reactor was used, were similar to that in the case where the temperature of the thermocatalytic reactor was 550-600° C. In the dielectric barrier discharge plasma reactor, the reactor temperature was room temperature, and thus the energy efficiency of a DBD reactor was greater than that of the thermocatalytic reactor.

The method for reforming carbon dioxide and methane using the catalyzed plasma reactor can enhance the energy efficiency and enhance the life of a catalyst.

Although exemplary embodiments have been described in detail with reference to the attached drawings, the disclosure is not limited to these embodiments. It is obvious that one skilled in the art to which the disclosure belongs can derive various examples of changes or modifications within the spirit and scope of the appended claims, and these naturally also fall within the technical scope of the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method for reforming carbon dioxide and methane by using a catalyzed plasma reactor, the method comprising:
providing a dielectric barrier discharge plasma reactor including a catalyst bed in a plasma discharge zone;
injecting a reaction gas into the plasma reactor;
generating a plasma within the plasma discharge zone of the plasma reactor;
generating a reformed gas by interaction between the plasma and the catalyst bed; and
separating the reformed gas,
wherein the reaction gas includes methane, carbon dioxide, oxygen, and inert gas,
the reformed gas includes carbon monoxide and hydrogen, and
the oxygen is about 2 volume percent to about 15 volume percent of a total volume of the reaction gas.

2. The method of claim 1, wherein the methane is about 10 volume percent to about 30 volume percent of the total volume of the reaction gas.

3. The method of claim 1, wherein the carbon dioxide is about 15 volume percent to about 45 volume percent of the total volume of the reaction gas.

4. The method of claim 1, wherein the plasma reactor comprises:
a body providing a plasma discharge zone;
an internal electrode within the plasma discharge zone;
an external electrode defining the plasma discharge zone and disposed on an outer surface of the body; and
a dielectric barrier between the internal electrode and the external electrode.

5. The method of claim 4, wherein the body comprises the dielectric barrier.

6. The method of claim 5, wherein the body includes quartz.

7. The method of claim 4, wherein the external electrode includes a metal mesh.

8. The method of claim 1, wherein the catalyst bed includes Ni, Cu, Pd, Pt, Ag, Fe, or a combination thereof.

9. The method of claim 1, wherein the catalyst bed includes a metal oxide doped with Ni, Cu, Pd, Pt, Ag, Fe, or a combination thereof.

10. The method of claim 1, wherein the catalyst bed includes a metal oxide coated with Ni, Cu, Pd, Pt, Ag, Fe, or a combination thereof.

11. The method of claim 9, wherein the metal oxide includes Al₂O₃, SiO₂, MgO, CeO₂, or a combination thereof.

12. The method of claim 1, wherein the catalyst bed includes Ni/Al₂O₃, Ni/SiO₂, Ni/MgO, Cu/Al₂O₃, Pd/Al₂O₃, Pd/CeO₂, Pt—Re/Al₂O₃, Ag/Al₂O₃, Fe/Al₂O₃, LaFeO₃, La₂O₃, Ni/MgAl₂O₄, NiFe₂O₄/SiO₂, Ni/Al₂O₃—MgO, BaFe_{0.5}Nb_{0.5}O₃, LaNi₂O₃/SiO₂, Na-ZSM-5, TiO₂/g-C₃N₄, BaTiO₃, or a combination thereof.

13. The method of claim 1, wherein, in the generating of the reformed gas, a coke disposed on a surface of the catalyst bed is removed by reaction with oxygen species generated by the plasma.

14. The method of claim 1, wherein, after the generating of the reformed gas, the catalyst bed does not include the coke.

15. The method of claim 1, wherein a temperature of the plasma discharge zone is about 15° C. to about 35° C.

16. The method of claim 1, wherein a flow rate of the reaction gas per weight of a catalyst is about 0.1 to 10 liters per hour-gram.

17. The method of claim 1, wherein the inert gas includes helium, nitrogen, argon, or a combination thereof.

18. The method of claim 4, wherein the generating of the plasma comprises applying an alternating current pulse voltage to the internal electrode.

19. The method of claim 18, wherein the alternating current pulse voltage has a frequency of about 40 kilohertz to about 90 kilohertz, a peak voltage of about 1 kilovolts to about 3 kilovolts, and a pulse width of about 1 microseconds to about 9 microseconds.

20. The method of claim 1, wherein some of the reformed gas passes through a component analyzer.
